(19) United States
(12) Patent Application Publication
(10) Pub. No.: US 2025/0274719 A1
(43) Pub. Date: Aug. 28, 2025

(54) METHOD AND SYSTEM FOR WIRELESS RANGING WITH A VEHICLE

(71) Applicant: Continental Automotive Technologies GmbH, Hannover (DE)

(72) Inventor: Brian Sunil Nicholas Fernandes, Singapore (SG)

(73) Assignee: Continental Automotive Technologies GmbH, Hannover (DE)

(21) Appl. No.: 19/058,872

(22) Filed: Feb. 20, 2025

(30) Foreign Application Priority Data
Feb. 22, 2024 (GB) 2402493.7

(51) Int. Cl. H04W 4/02; B60R 25/20; B60R 25/24

(52) U.S. Cl. CPC H04W 4/023; B60R 25/209; B60R 25/245

(57) ABSTRACT

A method and system for wireless ranging with a vehicle are disclosed. The method includes communicating a plurality of user devices with a plurality of vehicle units to establish a wireless connection; performing ranging sessions between each of the plurality of user devices and the plurality of vehicle units, wherein each of the ranging sessions comprises a time taken between a user device and a respective vehicle unit, and wherein each of the ranging sessions are performed concurrently; generating, using an algorithm, a cumulative cycle matrix based on the time taken for performing each of the ranging sessions; and determining a position of each of the plurality of user devices relative to each of the plurality of vehicle units based on the cumulative cycle matrix.

### BRIEF DESCRIPTION OF THE DRAWINGS

Embodiments will be better understood and readily apparent to one of ordinary skill in the art from the following written description, by way of example only, and in conjunction with the drawings, in which:

FIG. 1 shows a diagram of exemplary wireless communication between a user device and a vehicle device;

FIG. 2 shows a diagram illustrating the sequence of wireless ranging between each user device and each vehicle unit in an example embodiment;

FIG. 3 shows a diagram illustrating a period T_{invisible} during wireless ranging between user devices and vehicle units in an example embodiment;

FIG. 4 shows a flow chart illustrating a method for wireless ranging with a vehicle in accordance with an example embodiment;

FIG. 5 shows a diagram illustrating a system for wireless ranging with a vehicle in accordance with an example embodiment;

FIG. 6 shows a schematic diagram illustrating exemplary flow of information between a user device and a vehicle unit in the system of FIG. 5;

FIG. 7 shows a cumulative cycle matrix for wireless ranging with a vehicle in accordance with an example embodiment;

FIG. 8 shows a diagram illustrating a reduced sequence of wireless ranging between each user device and each vehicle unit in accordance with an exemplary embodiment.

Like numerals denote like parts.

### DETAILED DESCRIPTION

This disclosure generally relates to methods and systems for wireless ranging with a vehicle.

Currently, the use of multiple wireless transceivers (TRx) using different wireless ranging methods are available in different wireless standards such as Low Frequency (LF), High Frequency (HF), Bluetooth (BLE), Ultra-wideband (UWB), WIFI, Microwave, 4G, 5G, mmWave, as well as Radar and Terahertz (THz) communication and other wireless communication standards. Each of these wireless communications use different methods for communication and may be used to provide direction, ranging, positioning or other information of differing accuracy. They can also provide a wireless ranging profile using methods such as Channel Sounding, Time of Arrival, Time Difference of Arrival, Angle of Arrival, Time of Reflection, General Wireless Communication, Sensing over Wireless Communication, other methods etc.

With the advancement of technology in automobiles, determining the position of users and user devices around the vehicle periphery (whether inside or outside the vehicle) can be important in the features of a new vehicle. Further, there is also a growing need for personalization in vehicles by vehicle owners and vehicle lessors.

In recent times, vehicle manufacturers started to provide vehicle personalization features to users and owners. For example, opening or locking a vehicle door when the user walks towards or away from a vehicle. In another example, switching on the lights and then switching them off when the user is in a dark area or at night can provide the user or owner of the vehicle the comfort of having their path lighted while they are in a specific zone of operation of the vehicle. A further example of a personalization feature includes user authentication and pre-unlocking of the vehicle door when the vehicle user is at a pre-determined distance away from the vehicle. This allows the door handle to be opened and the vehicle is unlocked quickly to provide a seamless experience to the user.

In another example, the vehicle may lock all other vehicle doors and open or unlock only the vehicle door at which the user is walking towards so as to keep the vehicle secure from unwanted access or from malicious intent. Other current vehicle features include cooling or heating of the car before the user enters the car in hot or cold climates respectively, adjustments to the user seat, wheel positions, rear view mirrors etc., for the particular user when the car senses the user enters the driver's side door, the personal preferences in the user's WIFI or BLE access profile or other digital profile, audio or internet or other vehicle electronics or comfort features, the identification, medical details and/or the user's health condition, details used in emergency calls, telematics or satellite communication (satcom) features during an emergency response or any other application whether user specific or user agnostic.

However, many of such features rely heavily on the accumulation of data from multiple wireless transceivers around the vehicle communicating to a user device cumulatively in a continuous fashion, with the intention of using this wirelessly transmitted information and data to precisely locate the user, identify their intention to approach a particular vehicle and/or identify their trajectory towards, away from or parallel or other trajectory with reference to the vehicle's body and position in order to predict the position and movement of the user over time and in the future context.

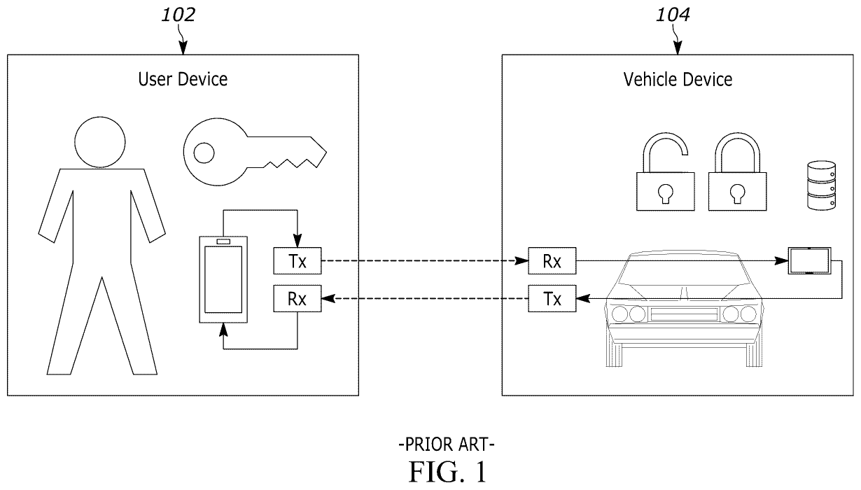

An important aspect of the above-mentioned functions is the authentication and sensing of the user using wireless communication and wireless sensing methods based on the user's device communicating wirelessly to vehicle devices. The user device could be a vehicle fob or a smartphone, a smart device or any device capable of wireless communication using any communication standard or method. In order to authenticate and locate the user, a vehicle unit or vehicle device should also be present for wireless communication between the user device and the vehicle. The vehicle unit can be a wireless electronic control unit (ECU), a transceiver, a smart device or any other device capable of wireless communication. FIG. 1 shows an example of a typical wireless communication between a user device and a vehicle device.

The precise location of the user device can be achieved by using a number of vehicle transceivers that can implement a series of ranging distance (D) using Time of Flight (TOF), Time Difference of Arrival (TDOA), angle of arrival (AOA) or a multiplicity of other technologies, methods, algorithms and techniques to provide a distance, direction, range or position estimation of the user and the user device from the vehicle unit at any time interval (Tᵢₙₜₑᵣᵥₐₗ) of the user or users continuously over any period of time (T_{period}).

The reliability of wireless communication between the present wireless systems in the user devices and vehicle units are subjected to various conditions of the environment (such as fading, reflections, noise, interference) and other wireless phenomena and physical processes. Other factors include conditions of the vehicle system response time, vehicle system handling of the information from the multiplicity of vehicle devices communicating to the multiplicity of user devices in proximity to the vehicle and preventing the creation of blind periods during which the vehicle is not tracking a user due to other conditions. These conditions can interrupt and degrade the quality of the information and data collected over the air and in the vehicle as well as the wireless sensing data and communication, thus affecting the vehicle system accuracy and a loss of communication and reliability across different time periods.

There is therefore a need to provide a method and system that will overcome or at least ameliorate one or more of the disadvantages discussed above.

It is an object of the disclosure to provide a method and system that address one or more of the problems discussed above.

According to a first aspect, provided is a method for wireless ranging with a vehicle, comprising: communicating a plurality of user devices with a plurality of vehicle units to establish a wireless connection; performing ranging sessions between each of the plurality of user devices and the plurality of vehicle units, wherein each of the ranging sessions comprises a time taken between a user device and a respective vehicle unit, and wherein each of the ranging sessions are performed concurrently; generating, using an algorithm, a cumulative cycle matrix based on the time taken for performing each of the ranging sessions; and determining a position of each of the plurality of user devices relative to each of the plurality of vehicle units based on the cumulative cycle matrix.

Advantageously, the method and algorithm as provided herein may improve the efficiency of the positioning and ranging methods and cycles for multiple users with a vehicle and improve the time to estimate positioning when a large number of user devices are simultaneously operating around a given vehicle, or around a multiplicity of vehicles. This can result in improving the communication time between the user's smartphone (user device) and the vehicle transceiver (vehicle unit).

In an embodiment, the method further comprises scheduling the ranging sessions based on the respective time of each of the ranging sessions.

Advantageously, this may allow each unique vehicle unit to user device combination to range at any given time and may thus allow such ranging cycles to operate in parallel. This can also reduce ranging time by a significant factor.

In an embodiment, the method further comprises prioritizing access to the vehicle by a user based on the distance of the user device to the vehicle.

Advantageously, this can lead to a reduction in time when a user device is invisible to a vehicle positioning system, as the alternate ranging with other devices takes up the system time.

In an embodiment, access to the vehicle comprises unlocking the doors of the vehicle and/or starting the engine of the vehicle.

Advantageously, this can allow real-time multiuser car sharing, where each of the users is positioned in a given space around the vehicle, to allow for a first-come first-served system of vehicle access and ranging by defining in ranging tables or a cumulative cycle matrix. This can also allow for a first-come first-served system of vehicle engine start permission when each of the users is positioned without delay in a given space around the vehicle. This can also allow for a first-come first-served system where multiple users access different doors in a vehicle.

In an embodiment, each of the plurality of user devices and each of the plurality of vehicle units comprises a transceiver capable of wireless communication.

Advantageously, this may allow real-time multiuser car sharing where each user in the vehicle operating space can avail a different position-specific feature in the vehicle.

In an embodiment, the algorithm is a precessing algorithm positioned within each of the plurality of vehicle units.

Advantageously, this may allow real-time multiuser car sharing, where each of the users is positioned in a given space around the vehicle, to allow for each user to access multiple comfort features in a vehicle. For example, one user is accessing the individual door, another user is using the boot, while another user needs light to guide them away from the vehicle in a zone of operation. In other words, the same vehicle can provide different benefits of comfort features to different users independently at the same time based on tracking their location inside or outside the vehicle.

According to a second aspect of the present disclosure, there is provided a system for wireless ranging with a vehicle, comprising: a plurality of vehicle units; a plurality of user devices, wherein each of the plurality of user devices is configured to: communicate with each of the plurality of vehicle units to establish a wireless connection; perform ranging sessions between each of the plurality of user devices and the plurality of vehicle units, wherein each of the ranging sessions comprises a time taken between a user device and a respective vehicle unit, and wherein each of the ranging sessions are performed concurrently; a processing unit, comprising an algorithm and configured to: generate a cumulative cycle matrix based on the time taken for performing each of the ranging sessions; and determine a position of each of the plurality of user devices relative to each of the plurality of vehicle units based on the cumulative cycle matrix.

Advantageously, the system as disclosed can properly allocate the ranging cycle to each user and may avoid invisible time and time-based malicious attack vectors. By the use of Ranging Allocation Tables or a Cumulative Cycle Matrix as disclosed, the system may provide superior time response in the positioning of the user with multiple vehicle units. The system may also provide better security in terms of system scalability when the number of users increases around the vehicle and the number of vehicle units are also increased.

In an embodiment, the processing unit is further configured to schedule the ranging sessions based on the respective time of each of the ranging sessions.

Advantageously, the system as disclosed can arrange ranging cycles in vehicle transceiver systems to allow for prescheduled ranging when a large number of user devices are around a given vehicle transceiver system.

In an embodiment, the processing unit is further configured to prioritize access to the vehicle by a user based on the distance of the user device to the vehicle.

Advantageously, this may allow real-time multiuser car sharing, in the case of a very large vehicle such as a bus or a van, where each user in the vehicle system can access the door individually without compromising the vehicle access security by an unauthorized user. This can also lead to the use of individualized specific features based on the user's specific location in a vehicle, such as aircon vent control, individual mood lighting, or specific seat configuration, seat heating and cooling, seat biological monitoring functionality, user health access systems, etc., for the specific user in the given seat or other user accessible features in the vehicle.

In an embodiment, the processing unit is positioned within each of the plurality of vehicle units.

Advantageously, this may allow for real-time multiuser car sharing for a small vehicle or for a very large vehicle such as a bus or a van or a truck or a lorry or an aircraft, when each user in the vehicle system can be individually positioned based on their devices. In the situation where there are different user smartphones or smart devices, this can allow the use of different ranging techniques and other wireless radio frequency (RF) over the air (OTA) protocols such as Bluetooth (BLE), Ultra Wideband (UWB), 5G, Sidelink, Global Positioning System (GPS), WIFI or any other wireless RF, Low Frequency (LF) or microwave or millimetre wave RF system with ranging, angle of arrival, Received Signal Strength Indicator (RSSI) or Time of Flight (TOF), or other applicable positioning features which requires communication between two nodes of a wireless or wired system.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

The present disclosure also discloses a user device or user devices. It will be appreciated the user device or the user devices can include potentially any device which has a wireless communication and sensing Transmitter and Receiver system using potentially any or all of a multiplicity of Wireless communication standards such as Bluetooth (BLE), Wi-Fi, 4G, 5G, mmWave, Terahertz, or any other future wireless standards. The user device or user devices may include all the requisite wireless communication standards that are necessary for this functionality and includes the possibility of extensive authentication features using onboard computing power as well as potential cloud-based computing power.

Similarly, the present specification also discloses a vehicle unit (vehicle device) or vehicle units (vehicle devices). It will be appreciated the vehicle unit or vehicle units can include potentially any device which has a wireless communication and sensing Transmitter and Receiver system using potentially any or all of a multiplicity of Wireless communication standards like Bluetooth (BLE), WIFI, 4G, 5G, mmWave, Terahertz, or any other future wireless standards. The vehicle unit or vehicle units may include all the requisite wireless communication standards that are necessary for this functionality and includes the possibility of extensive authentication features using onboard computing power as well as potential cloud-based computing power.

In any wireless system, the quality of communication may be limited to the amount of useable power in the wireless system, the available sensitivity in the wireless system and usable Wireless Communication Link Budget in the Low Frequency (LF), Radio Frequency (RF) and Microwave and millimetre wave (mmWave) or higher frequencies together with their directional efficiency in the Wireless System. Although this constitutes a link budget, it is also important for the wireless system to have sufficient margin to be able to withstand variations in this power and degradation of the sensitivity due to the signal distortion or wireless interference under the wireless operating environment conditions and performance. FIG. 1 shows a diagram of a typical wireless communication between a user device 102 and a vehicle device 104 (or vehicle unit). The wireless communication may be via Low Frequency (LF), Radio Frequency (RF), Microwave and millimetre wave (mmWave) or higher frequencies, using any wireless communication method or standard defined or proprietary, with a transmitter (TX) and receiver (RX) defined for the vehicle wireless device 104 (or vehicle wireless unit) as well as the user wireless device 102. The wireless communication may also involve associated keys, authentication protocol, and other peripheral features, like a database and/or the use of the controller, encryption and decryption methods, computer or other computing or actuating devices.

To overcome the loss of data or to overcome inaccuracies in the accumulated data collected from the ranging information or other information collected on the user device or user devices, it may be desirable to define the vehicle and its system when referring to one user device and one vehicle device during the process of estimating the position of the user. While the actual system may have a plurality of user devices and a plurality of vehicle devices, the user device and the vehicle device are a set of interoperable devices that can communicate with each other to and from, using an uplink or downlink, half duplex or full duplex mode of communication with periodic wireless information transfer, wireless synchronization, device wakeup and other wireless functionality needed to provide a robust communication platform and regular operation. The vehicle system may have a multiplicity of such vehicle devices and a multiplicity of such user devices that need to be precisely positioned around the vehicle.

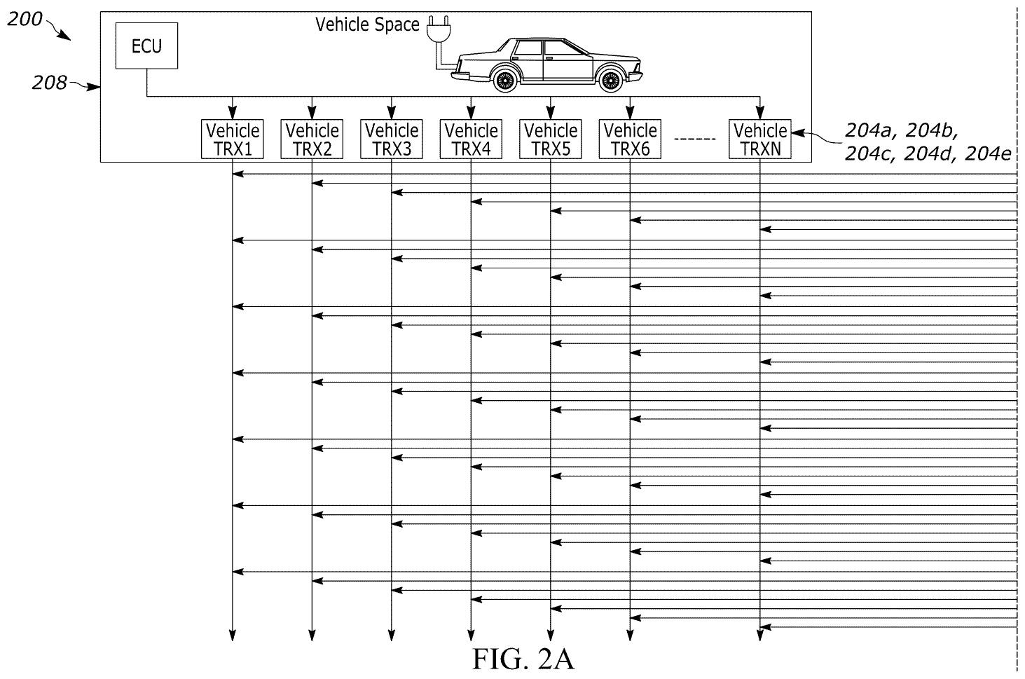

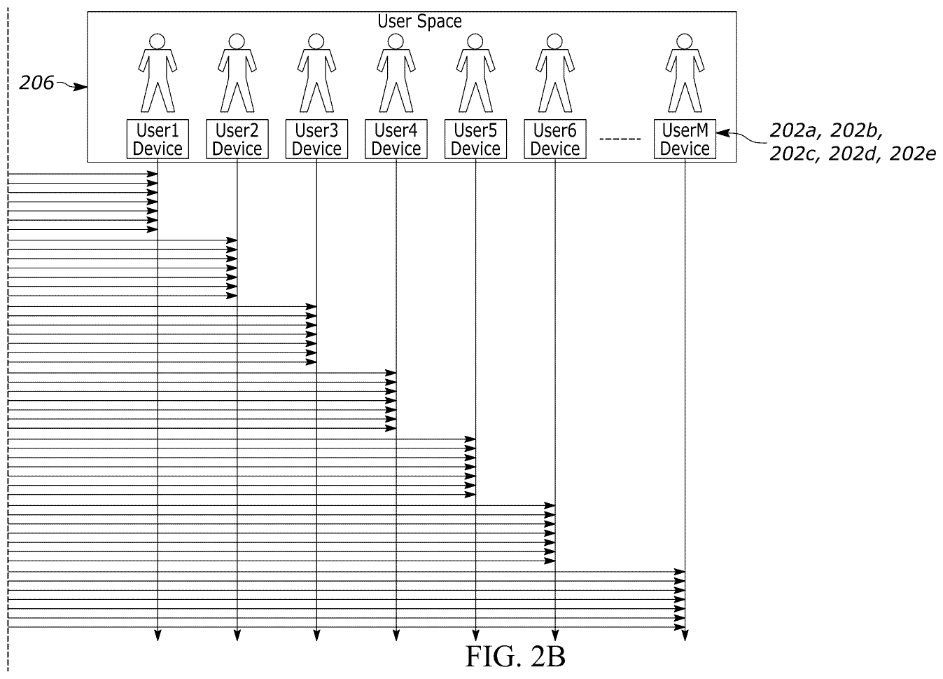

FIG. 2 shows a diagram 200 illustrating the sequence of wireless ranging between each user device and each vehicle unit in an example embodiment. In the user space 206, there may be multiple users that are interested to enter into the vehicle space 208, with each user having a user device 202a and each vehicle having a vehicle unit 204a (or vehicle device). For example and as shown in FIG. 2, they may be M users with user devices 202a, 202b, 202c, 202d, 202e located around a vehicle having N transceivers or vehicle units 204a, 204b, 204c, 204d, 204e. Each user is equipped with a single transceiver in their user device, which can be a User Equipment (UE), Smartphone (SP) or any Smart Device that they are carrying. It can also be embedded within or without any active knowledge of the user and each individual user needs to be precisely located and securely authenticated using this device. The authentication of the user device 202a of each user can be done using authentication criteria of different methods, which may include physical or virtual keys, tokens or protocols with or without secure authentication. The location, positioning or ranging of each user device 202a in the user space 206 is done using wireless transceivers in the vehicle units 204a, 204b, 204c, 204d, 204e and the user devices 202a, 202b, 202c, 202d, 202e.

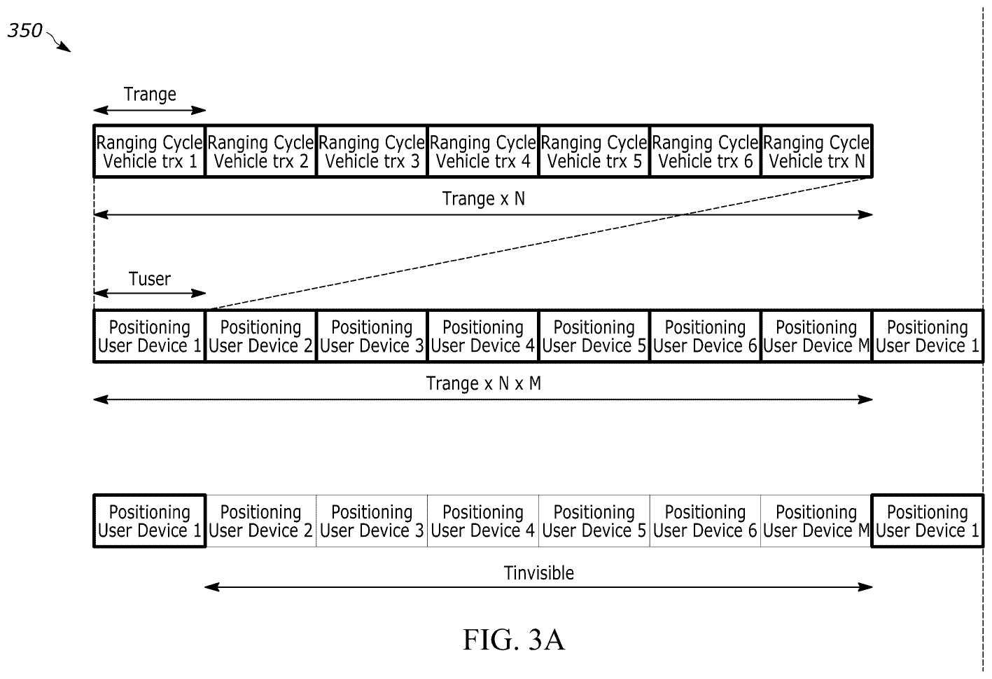

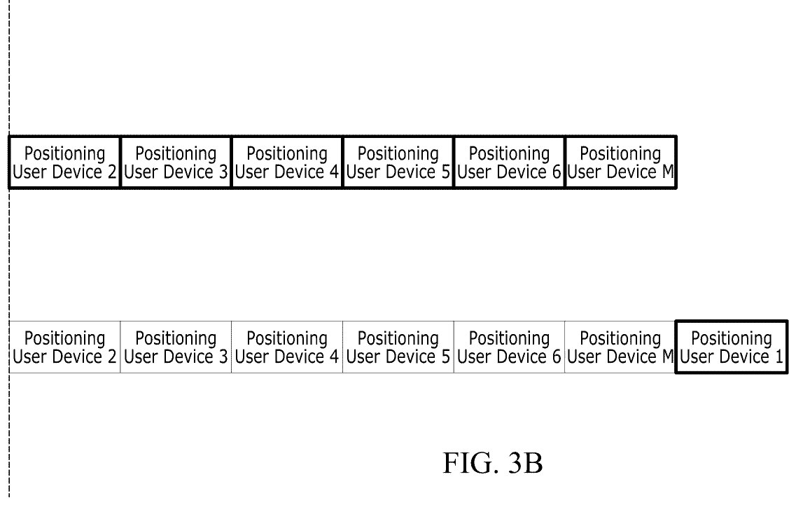

The wireless lines of communication between the different sets of users and vehicle units would look similar to a M by N system of M users and N vehicle units respectively. In FIG. 2, each vehicle unit 204a performs an accurate ranging session with a single user via the user device 202a so as to be able to precisely locate the user around the vehicle within a time interval T_{range} (see FIG. 3). This can be carried out via sending and receiving data or signals between each user device 202a and each vehicle unit 204a. The time interval Tᵤₛₑᵣ (see FIG. 3) is the time taken for all of the plurality of vehicle units 204a, 204b, 204c, 204d, 204e to communicate and range with a single user device 202a, including processing the data and provide a position outcome of the user relative to the vehicle. Accordingly, for multiple number of M user devices 202a, 202b, 202c, 202d, 202e, ranging cycles are done in sequence, i.e. in series. For example, the time taken for each user device 202a to complete a single ranging session with each vehicle unit 204a is T_{range}, then for N number of vehicle units 204a, 204b, 204c, 204d, 204e, the ranging cycle will take Tᵤₛₑᵣ=T_{range}×N to complete an accurate precise positioning of one user device 202a. This is repeated in series for the next user device 202b ranging cycle until all the M number of user devices 202a, 202b, 202c, 202d, 202e are completed. This may be due to the limitation in any ranging cycle where it can only be accomplished based on a one-to-one communication between the subject user device 202a and the respective vehicle unit 204a.

FIG. 3 shows a diagram 350 illustrating a period T_{invisible} during wireless ranging between user devices and vehicle units in an example embodiment. Accordingly, when there are M number of user devices 202a, 202b, 202c, 202d, 202e, it will take a period of T_{range}×N×M to complete the ranging cycles on all of the user devices 202a, 202b, 202c, 202d, 202e, which can be an inordinate amount of time if M is sufficiently large. Each device-to-device ranging is carried out in series due to the design scheduling and thus the total ranging time to be able to calculate the position of all users around the vehicle, will be M×N×T_{range} as shown in FIG. 3. This may result in large time gaps in the positioning of any one user device 202a, which can allow a malicious actor to execute a physical attack on the system in the interim. The system may not be aware of the malicious user device, for a period of T_{invisible}, while it is ranging the other devices in the system, where T_{invisible}=T_{range}×N×(M−1). This bottle neck in communication is caused by the fact that any one device (e.g. user device 202a) can only range wirelessly with another single device (e.g. vehicle unit 204a) at any given time, and thus creates a bottle-neck as each vehicle unit 204a communicates in series to the user device 202a.

In an embodiment shown in FIG. 3, a considerable invisible time T_{invisible} may be available when there are a significantly large number of users M in the user space 206. This may lead to potential mis-tracking of the large number of users M, particularly if they are moving faster than normal, and also a potential exploit for an attacker since the user device 202a is not tracked in real time during the invisible time period.

In an embodiment, the potential exploit may involve an attacker inserting a non-compliant User Equipment (UE) or Smartphone (SP) during the ranging. When the non-compliant UE or SP is queried during a ranging session and a non-compliant answer is provided, all of the queries to each user device 202a will be reinitiated due to a possible fault identification in the ranging cycles. This can result in the legitimate UE or SP not being tracked or delaying tracking time in the tracking of any given user device that will allow the attacker to fool the system into thinking the users are closer or further away than they really are.

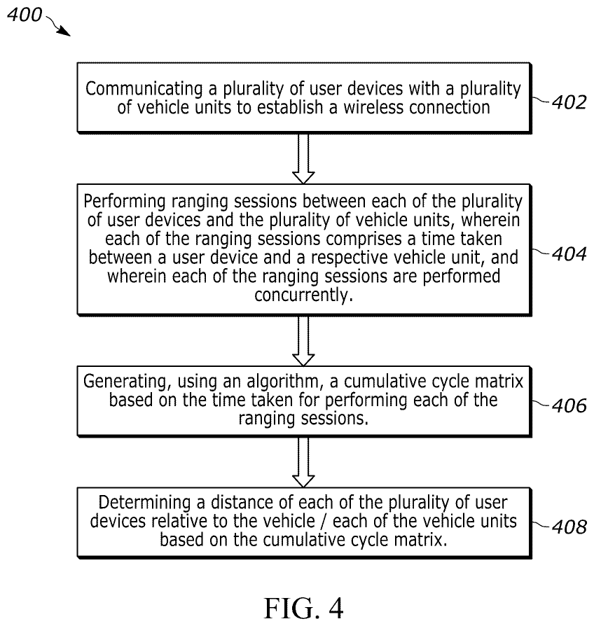

FIG. 4 shows a flow chart illustrating a method 400 for wireless ranging with a vehicle in accordance with an embodiment. At step 402, the method 400 includes communicating a plurality of user devices with a plurality of vehicle units to establish a wireless connection. Each of the plurality of user devices and each of the plurality of vehicle units may include a transceiver capable of wireless communication. At step 404, the method includes performing ranging sessions between each of the plurality of user devices and the plurality of vehicle units, wherein each of the ranging sessions comprises a time taken between a user device and a respective vehicle unit, and wherein each of the ranging sessions are performed concurrently. The time taken may include the total time taken the user device and the respective vehicle unit to establish a wireless connection. At step 406, the method includes generating, using an algorithm, a cumulative cycle matrix based on the time taken for performing each of the ranging sessions. The algorithm can be a precessing algorithm positioned within each of the plurality of vehicle units. At step 408, the method includes determining a position of each of the plurality of user devices relative to each of the plurality of vehicle units based on the cumulative cycle matrix. In an example embodiment, determining the position of each of the plurality of user devices may include determining any one of the following but not limited to the distance, location and/or direction of the user device from the respective vehicle unit.

The method may further include scheduling the ranging sessions based on the respective time of each of the ranging sessions and prioritizing access to the vehicle by a user based on the distance of the user device to the vehicle. Access to the vehicle may include unlocking the doors of the vehicle and/or starting the engine of the vehicle.

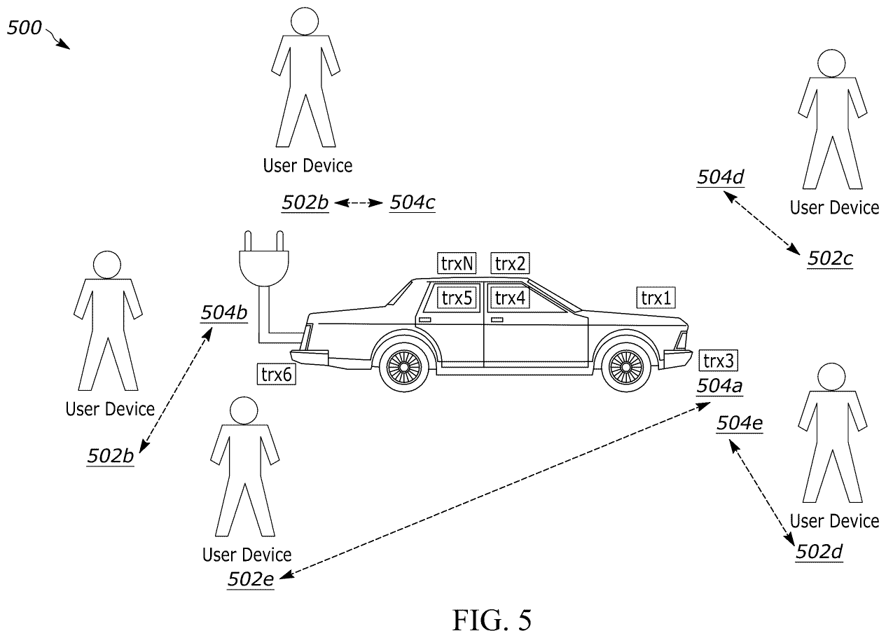

FIG. 5 shows a diagram illustrating a system 500 for wireless ranging with a vehicle in accordance with an embodiment. The system 500 includes a plurality of user devices 502a, 502b, 502c, 502d, 502e and a plurality of vehicle units 504a, 504b, 504c, 504d, 504e. Each of the plurality of user devices 502a, 502b, 502c, 502d, 502e is configured to communicate with each of the plurality of vehicle units 504a, 504b, 504c, 504d, 504e to establish a wireless connection and perform ranging sessions between each of the plurality of user devices 502a, 502b, 502c, 502d, 502e and the plurality of vehicle units 504a, 504b, 504c, 504d, 504e.

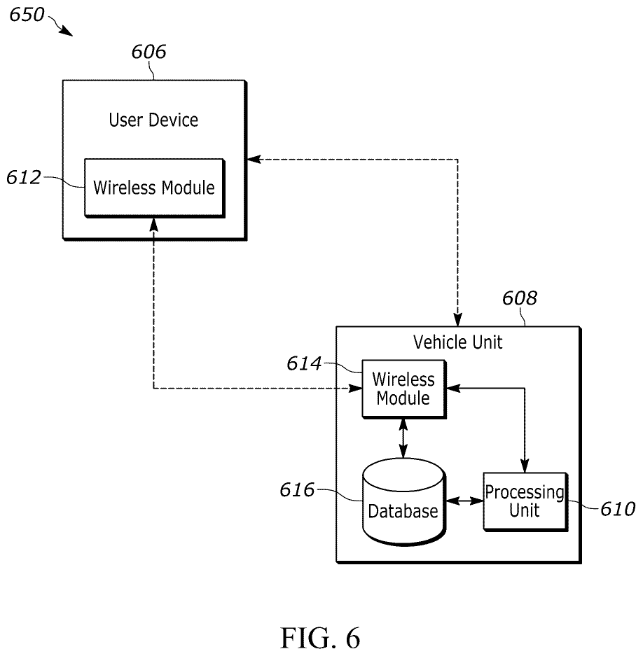

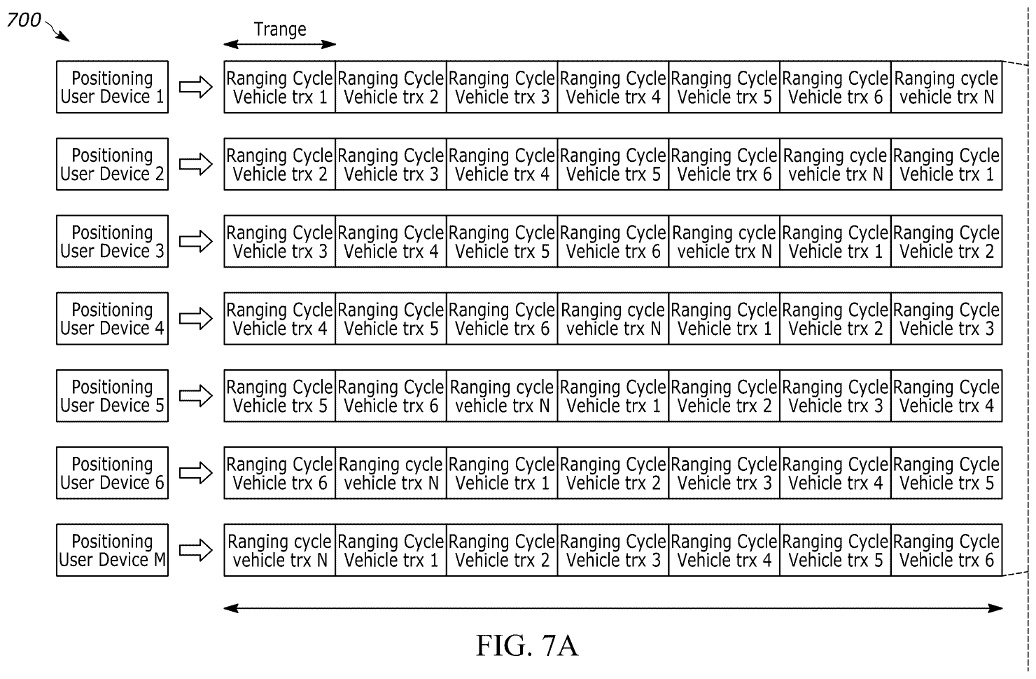

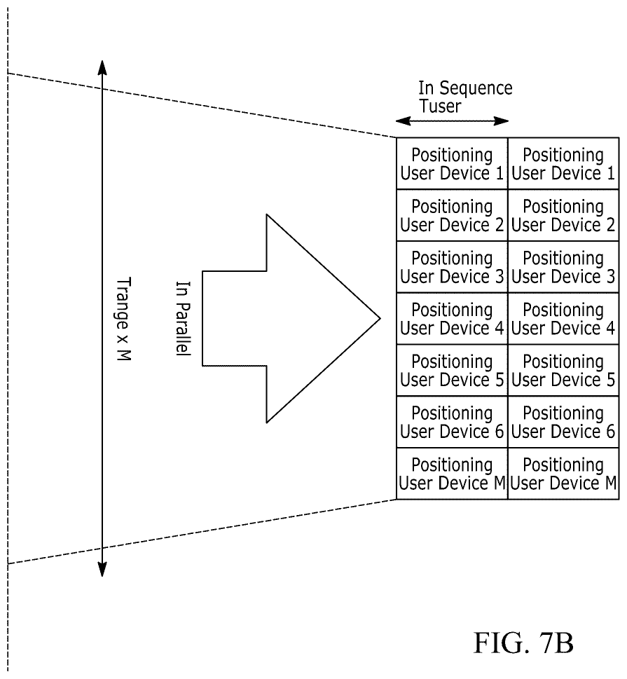

FIG. 6 shows a schematic diagram illustrating the flow of information 650 between a user device 606 and a vehicle unit 608 in the system of FIG. 5. Each of the ranging sessions performed by the user device 606 comprises a time taken between the user device 606 and a respective vehicle unit 608, and each of the ranging sessions are performed concurrently. The time taken may include the total time for the user device and the respective vehicle unit to establish a wireless connection. The system further includes a processing unit 610, comprising an algorithm and configured to generate a cumulative cycle matrix or a ranging table (see FIG. 7) based on the time taken for performing each of the ranging sessions. The algorithm may be a precessing algorithm and the processing unit is positioned within each of the plurality of vehicle units 608. The processing unit 610 may also determine a position of each of the plurality of user devices 606 relative to each of the plurality of vehicle units 608 based on the cumulative cycle matrix. In an example embodiment, the processing unit 610 may determine the position of each of the plurality of user devices 606 based on any one of the following but not limited to the distance, location and/or direction of the user device 606 from the respective vehicle unit 608.

The processing unit 610 may be further configured to schedule the ranging sessions based on the respective time of each of the ranging sessions and prioritize access to the vehicle by a user based on the distance of the user device 606 to the vehicle. As shown in FIG. 6, the user device 606 may include a wireless module 612 which can wirelessly communicate with a wireless module 614 of the vehicle unit 608. The wireless communication may include transmitting and receiving radio signals or data between the wireless modules 612, 614 for authentication and positioning. In an example embodiment, the wireless module 614 of the vehicle unit 608 may communicate with the processing unit 610 using radio frequency (RF) during a ranging session so as to determine the time taken for the user device 606 to establish the wireless connection with the vehicle unit 608. It can be appreciated that other types of wireless communication may be possible between the wireless module 614 and processing unit 610. In an alternate embodiment, the wireless module 614 and processing unit 610 may be wired. The vehicle unit 608 may also include a database 616 that is in communication with the processing unit 610 and the wireless module 614. The database 616 may store data received by the wireless module 614, for example a unique user device identification, as well as storing data from the processing unit 610, such as the time taken to complete a single ranging session. This can allow the processing unit 610 to authenticate the user device 606 and subsequently perform a ranging session with the user device 606 to determine the position of the user device 606.

In an example embodiment, the vehicle units 504a, 504b, 504c, 504d, 504e of FIG. 5 can be transceivers (TRx) that can both transmit and receive a wireless RF signal with a predetermined communication protocol. This can be realized using predefined RF Frequencies, RF modulation and coding schemes, included together with some form of Wake up, Synchronization patterns, frame rate and other wireless communication parameters. These TRx may be located at predesignated locations around the vehicle in terms of both height from the ground as well as position and orientation around the vehicle body. This may allow separation between a vehicle space that is secured and a user space which is unsecured.

The method 400 and system 500 according to an example embodiment may overcome the gap in the communication and systematic tracking of each user as well as avoiding the invisibility period of any such user when communicating with the vehicle. The method 400 may follow a precession method in the communication protocols for the algorithm (or ranging algorithm) to allow for a cumulative ranging in the ranging cycles of the different user devices 502a, 502b, 502c, 502d, 502e and the different vehicle units 504a, 504b, 504c, 504d, 504e. This can allow the vehicle units 504a, 504b, 504c, 504d, 504e to execute the algorithm onboard and thus does not require an additional overhead communication of further translating the ranging information of each user to a separate central device. This can result in faster communication and may prevent the long lags and gaps between individual user positioning.

FIG. 7 shows a cumulative cycle matrix 700 for wireless ranging with a vehicle in accordance with an embodiment. Using a cumulative operational precessing algorithm (COPA), the communication is initiated between the vehicle unit 608 and the user device 606 in an inordinate cycle in a precessing format. This can reduce the time between positioning of the user between each ranging cycle and may prevent a malicious actor to identify the next device in the ranging cycle by different methods of elimination. In an embodiment using COPA, ranging cycles are conducted by the multiple vehicle units 504a, 504b, 504c, 504d, 504e with the multiple user devices 502a, 502b, 502c, 502d, 502e in parallel. This is due to the use of the Ranging Allocation Tables (or the cumulative cycle matrix 700) and based on a predetermined and preassigned ranging assignment so that the amount of ranging time can be reduced significantly. In this case and as shown in FIG. 7, the total ranging time is (M//N)×T_{range}.

In an example embodiment when the number of users M is equal to the number of vehicle units N, the ranging cycles and the ranging sessions are distributed over time using the precessing algorithm. This may allow the system 500 to handle multiple users in parallel without affecting the time lag and provide a nearly adjacent tracking time with no lag and significantly reduced invisibility time between each position of a given user. This is in contrast to a ranging session where the system and overhead algorithm protocol create large gaps in the ranging cycles between individual users. When the number of users M is equal to number of vehicle units N 504a, 504b, 504c, 504d, 504e, each vehicle unit 608 is assigned a starting user to range with and continues with the next user in the ranging table or cumulative cycle matrix such that one vehicle unit 608 is assigned to one user device 606 in each ranging or positioning cycle. Subsequently, the assignment is rotated around the table or matrix as shown in FIG. 7. This may allow for significant time saving as well as increase in the operational efficiency over the previous per user ranging system (see FIG. 2) and may completely remove the T_{invisible} time (see FIG. 3) without compromising with the Tᵤₛₑᵣ time. This can lead to a reduction in time when a user device 606 is invisible to a vehicle positioning system, as the alternate ranging with other devices takes up the system time.

In another embodiment, when the number of users M are less than or equal to the number of vehicle units N 504a, 504b, 504c, 504d, 504e, the ranging table or the cumulative cycle matrix is shorter and the Tᵤₛₑᵣ time increases over the previous embodiment. The total time taken in this case is N×T_{range}. However, this time is shorter than the sequence of FIG. 2. Also, the T_{invisible} time is also significantly shorter than the sequence of FIG. 2 when there is more than one user in the system.

In a further embodiment, where the number of users M are more than the number of vehicle units N 504a, 504b, 504c, 504d, 504e, the ranging table or the cumulative cycle matrix is longer and the Tᵤₛₑᵣ time then increases over the previous embodiment. The total time taken in this case is M×T_{range}. However, this time is shorter than the sequence of FIG. 2. Even though T_{invisible} for any given user device 606 may get longer when M is very much greater than N but the T_{invisible} is significantly shorter than the sequence of FIG. 2.

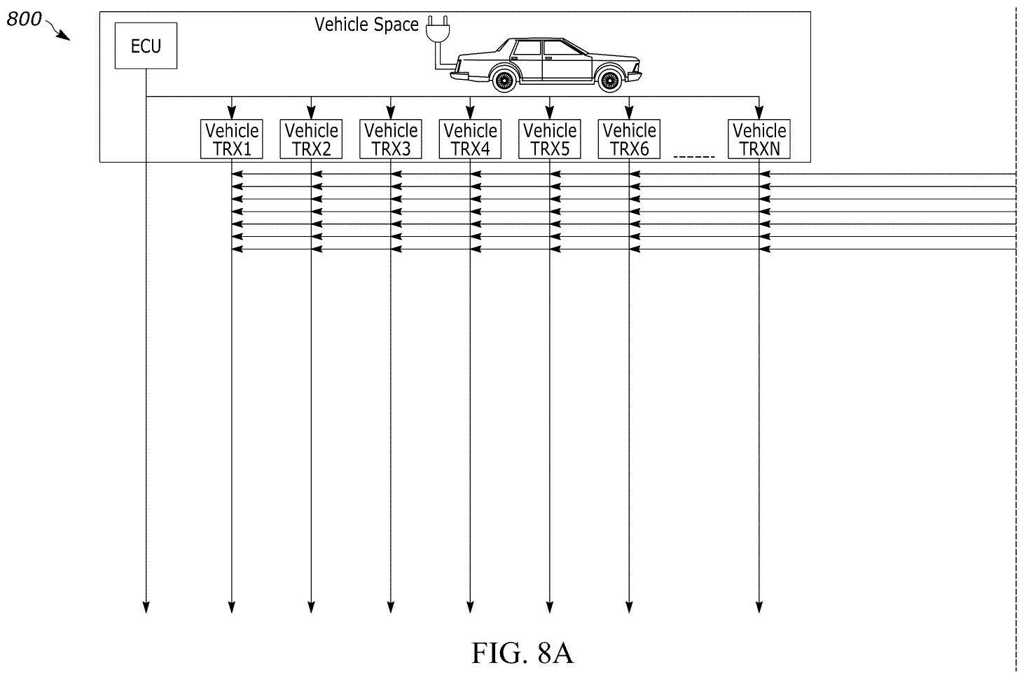

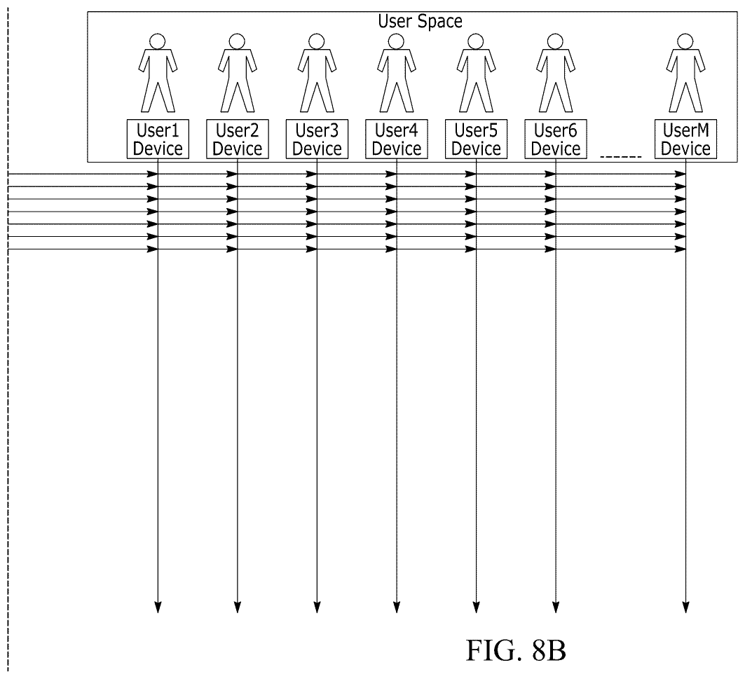

FIG. 8 shows a diagram illustrating the reduced sequence of wireless ranging 800 between each user device and each vehicle unit in accordance with an embodiment. As compared to the sequence of FIG. 2, the method and system can lead to significant time saving in Total Ranging Time (TRT) through the use of the algorithm or Cumulative Operational Precessing Algorithm (COPA) and the use of the Ranging Allocation Tables or the cumulative cycle matrix 700 and also by conducting the ranging cycles in parallel. The improved configuration using COPA in the Ranging Allocation Tables and in the cumulative cycle matrix 700 may allow all users to be tracked simultaneously, so that there is no invisible time (T_{invisible}) in the tracking of any given user. This can allow for a first-come first-served system of vehicle engine start permission when each of the users is positioned without delay in a given space around the vehicle. This can also allow for a first-come first-served system where multiple users access different doors in a vehicle. This may also allow real-time multiuser car sharing, where each of the users is positioned in a given space around the vehicle, to allow for each user to access multiple comfort features in a vehicle. For example, one user is accessing the individual door, another user is using the boot, while another user needs light to guide them away from the vehicle in a zone of operation. In other words, the same vehicle can provide different benefits of comfort features to different users independently at the same time based on tracking their location inside or outside the vehicle.

In an embodiment, an additional security measure can be added in the algorithm so as to time synchronize the cumulative cycle matrix 700 responses with a time stamp. The algorithm can also reallocate or reconfigure the ranging tables (or cumulative cycle matrix 700) in a fixed order for every ranging cycle so that only the vehicle unit 608 knows the ranging table (or cumulative cycle matrix 700) while the user devices 502a, 502b, 502c, 502d, 502e are unaware of the ranging tables (or cumulative cycle matrix 700). This is because the user devices 502a, 502b, 502c, 502d, 502e only respond to a ranging query when they receive a query addressed to the specific user device 606. This may allow for an additional layer of security because any attacker will not know the sequence of when the next user device 606 will be queried and thus unable to selectively jam or co-operate a specific phone at a given time interval. This can prevent an attack of a hostile malicious actor user device added into the system 500.

It will be appreciated by a person skilled in the art that numerous variations and/or modifications may be made to the specific embodiments without departing from the spirit or scope of the invention as broadly described. The present embodiments are, therefore, to be considered in all respects to be illustrative and not restrictive.

1. A method for wireless ranging with a vehicle, comprising:
communicating a plurality of user devices with a plurality of vehicle units to establish a wireless connection;
performing ranging sessions between each of the plurality of user devices and the plurality of vehicle units, wherein each of the ranging sessions comprises a time taken between a user device and a respective vehicle unit, and wherein each of the ranging sessions are performed concurrently;
generating, using an algorithm, a cumulative cycle matrix based on the time taken for performing each of the ranging sessions; and
determining a position of each of the plurality of user devices relative to each of the plurality of vehicle units based on the cumulative cycle matrix.

2. The method according to claim 1, further comprising:
scheduling the ranging sessions based on the respective time of each of the ranging sessions.

3. The method according to claim 2, wherein each of the plurality of user devices and each of the plurality of vehicle units comprises a transceiver capable of wireless communication.

4. The method according to claim 2, wherein the algorithm is a precessing algorithm positioned within each of the plurality of vehicle units.

5. The method according to claim 2, further comprising:
prioritizing access to the vehicle by a user based on distance of the user device to the vehicle.

6. The method according to claim 5, wherein access to the vehicle comprises unlocking a door of the vehicle and/or starting an engine of the vehicle.

7. The method according to claim 1, further comprising:
prioritizing access to the vehicle by a user based on a distance of the user device to the vehicle.

8. The method according to claim 7, wherein access to the vehicle comprises unlocking a door of the vehicle and/or starting an engine of the vehicle.

9. The method according to claim 1, wherein each of the plurality of user devices and each of the plurality of vehicle units comprises a transceiver capable of wireless communication.

10. The method according to claim 1, wherein the algorithm is a precessing algorithm positioned within each of the plurality of vehicle units.

11. A system for wireless ranging with a vehicle, comprising:
a plurality of vehicle units;
a plurality of user devices, wherein each of the plurality of user devices is configured to:
communicate with each of the plurality of vehicle units to establish a wireless connection;
perform ranging sessions between each of the plurality of user devices and the plurality of vehicle units, wherein each of the ranging sessions comprises a time taken between a user device and a respective vehicle unit, and wherein each of the ranging sessions are performed concurrently;
a processing unit, comprising an algorithm and configured to:
generate a cumulative cycle matrix based on the time taken for performing each of the ranging sessions; and
determine a position of each of the plurality of user devices relative to each of the plurality of vehicle units based on the cumulative cycle matrix.

12. The system according to claim 11, wherein the processing unit is further configured to:
schedule the ranging sessions based on the respective time of each of the ranging sessions.

13. The system according to claim 12, wherein each of the plurality of user devices and each of the plurality of vehicle units comprises a transceiver capable of wireless communication.

14. The system according to claim 12, wherein the algorithm is a precessing algorithm and the processing unit is positioned within each of the plurality of vehicle units.

15. The system according to claim 12, wherein the processing unit is further configured to:
prioritize access to the vehicle by a user based on a distance of the user device to the vehicle.

16. The system according to claim 15, wherein access to the vehicle comprises unlocking a door of the vehicle and/or starting an engine of the vehicle.

17. The system according to claim 11, wherein the processing unit is further configured to:
prioritize access to the vehicle by a user based on a distance of the user device to the vehicle.

18. The system according to claim 17, wherein access to the vehicle comprises unlocking a door of the vehicle and/or starting an engine of the vehicle.

19. The system according to claim 11, wherein each of the plurality of user devices and each of the plurality of vehicle units comprises a transceiver capable of wireless communication.

20. The system according to claim 11, wherein the algorithm is a precessing algorithm and the processing unit is positioned within each of the plurality of vehicle units.
